(19) United States
(12) Patent Application Publication
(10) Pub. No.: US 2019/0226525 A1
(43) Pub. Date: Jul. 25, 2019

(54) SLIDING MEMBER

(71) Applicant: NTN CORPORATION, Osaka-shi, Osaka (JP)

(72) Inventors: Takuji HARANO, Ama-gun, Aichi (JP); Toshihiko MOURI, Ama-gun, Aichi (JP)

(21) Appl. No.: 16/337,194

(22) PCT Filed: Sep. 28, 2017
(86) PCT No.: PCT/JP2017/035131

§ 371 Date: Mar. 27, 2019

(30) Foreign Application Priority Data
Sep. 28, 2016 (JP) 2016-189847
Sep. 28, 2016 (JP) 2016-189848
Sep. 27, 2017 (JP) 2017-186655
Sep. 27, 2017 (JP) 2017-186656

(51) Int. Cl. F16C 33/20; B22F 3/26; B22F 7/00; B22F 7/06; B22F 5/10; B22F 3/12

(52) U.S. Cl. CPC F16C 33/208; C10M 101/02; B22F 3/26; B22F 7/002; B22F 7/06; B22F 5/106; B22F 3/12; B22F 2998/10; B22F 2301/10; B22F 2301/30; C10M 2201/0413; C10N 2250/18; B22F 2301/35; F16C 2208/52; F16C 2206/06; F16C 33/201

(57) ABSTRACT

A sliding member having a sliding surface that is at least partially formed of a surface of a lubricating member is provided. The sliding member includes: a base body as a sintered body of a compact containing metal powder, the base body being integrated with the lubricating member; and the lubricating member as an injection molded product of a resin composition containing a polyarylene sulfide-based resin and a carbon material.

### TECHNICAL FIELD

The present invention relates to a sliding member having a sliding surface.

### BACKGROUND ART

Severe demands for the functions required for a sliding member having a solid lubricant embedded therein has been increasing year by year. This leads to a requirement for developing a solid lubricant that can keep excellent slidability for a long period of time and that can be manufactured at low cost.

As a sliding member having a solid lubricant embedded therein, for example, PTL 1 (Japanese Patent Laying-Open No. 2013-14645) proposes a sliding member that has a cylindrical base body provided with a radial through hole in which a sintered body made of artificial graphite as a main component is embedded as a solid lubricant.

### CITATION LIST

### Patent Literature

PTL 1: Japanese Patent Laying-Open No. 2013-14645

### SUMMARY OF INVENTION

### Technical Problem

However, in order to form a radial through hole in the base body and embedding a solid lubricant in this through hole, the solid lubricant needs to be fixed to the base body with high accuracy. In addition, the through hole in the base body and the solid lubricant fitted thereinto also need to be processed with high accuracy. Thus, there is room for improvement from view points of the working efficiency and the processing cost. Particularly when a carbon-based sintered body (sintered artificial graphite) is used as a solid lubricant, the carbon-based sintered body is less likely to be plastically deformed, which requires molding by cutting work and the like in order to increase the dimensional accuracy. This leads to a concern that the processing cost may be further increased. In addition, the structure having a solid lubricant embedded in a through hole leads to a concern that the solid lubricant may fall off from the base body of the sliding member during use of the sliding member.

Thus, the first object of the present invention is to provide a sliding member that can be improved in working efficiency and processing cost for manufacturing a sliding member. Furthermore, the second object of the present invention is to provide a sliding member that can be improved in working efficiency and processing cost for manufacturing a sliding member, and also that is reduced in probability that a solid lubricant may fall off from a base body of the sliding member during use of the sliding member.

### Solution to Problem

The present invention provides a sliding member as described below and a method of manufacturing the sliding member.

[1] A sliding member having a sliding surface that is at least partially formed of a surface of a lubricating member is provided. The sliding member includes: a base body as a sintered body of a compact containing metal powder, the base body being integrated with the lubricating member; and the lubricating member as an injection molded product of a resin composition containing a polyarylene sulfide-based resin and a carbon material.

[2] A sliding member having a sliding surface that is at least partially formed of a surface of a lubricating member is provided. The sliding member includes: a base body as a sintered body of a compact containing metal powder, the base body having a housing portion in which the lubricating member is to be housed; and the lubricating member as an injection molded product of a resin composition containing a polyarylene sulfide-based resin and a carbon material, the lubricating member being disposed inside the housing portion.

[3] In the sliding member described in [1] or [2], a content of the carbon material in the resin composition is approximately 5% by mass or more and approximately 70% by mass or less.

[4] In the sliding member described in any one of [1] to [3], the base body has an inner pore, and the inner pore is impregnated with lubricating oil.

[5] In the sliding member described in any one of [1] to [4], the base body has an open porosity of approximately 5% or more and approximately 50% or less.

[6] In the sliding member described in any one of [1] to [5], the base body has a surface porosity of approximately 10% or more and approximately 50% or less.

[7] In the sliding member described in [2], the housing portion of the base body has an inner surface having a surface porosity of approximately 10% or more and approximately 50% or less.

[8] In the sliding member described in any one of [1] to [7], the carbon material is at least one selected from the group consisting of a carbon nano fiber, carbon black and graphite

[9] A sliding member having a sliding surface that is at least partially formed of a surface of a lubricating member is provided. The sliding member includes: a base body as a sintered body of a compact containing metal powder, the base body being integrated with the lubricating member; and the lubricating member as an injection molded product of a resin composition containing a thermoplastic resin and a carbon material.

[10] A sliding member having a sliding surface that is at least partially formed of a surface of a lubricating member is provided. The sliding member includes: a base body as a sintered body of a compact containing metal powder, the base body having a housing portion in which the lubricating member is to be housed; and the lubricating member as an injection molded product of a resin composition containing a thermoplastic resin and a carbon material, the lubricating member being disposed in the housing portion.

[11] In the sliding member described in [9] or [10], a content of the carbon material in the resin composition is approximately 5% by mass or more and approximately 70% by mass or less.

[12] In the sliding member described in any one of [9] to [11], the base body has an inner pore, and the inner pore is impregnated with lubricating oil.

[13] In the sliding member described in any one of [9] to [12], the base body has an open porosity of approximately 5% or more and approximately 50% or less.

[14] In the sliding member described in any one of [9] to [13], the base body has a surface porosity of approximately 10% or more and approximately 50% or less.

[15] In the sliding member described in [10], the housing portion of the base body has an inner surface having a surface porosity of approximately 10% or more and approximately 50% or less.

[16] In the sliding member described in any one of [9] to [15], the carbon material is at least one selected from the group consisting of a carbon nano fiber, carbon black and graphite.

[17] A method of manufacturing a sliding member having a sliding surface that is at least partially formed of a surface of a lubricating member is provided. The method includes: sintering a compact containing metal powder to manufacture a base body; injecting a resin composition containing a carbon material and a thermoplastic resin to integrate the lubricating member with the base body.

[18] A method of manufacturing a sliding member having a sliding surface that is at least partially formed of a surface of a lubricating member is provided. The method includes: sintering a compact containing metal powder to manufacture a base body having a housing portion in which the lubricating member is to be housed; and injecting a resin composition containing a carbon material and a thermoplastic resin into the housing portion to dispose the lubricating member in the housing portion.

[19] In the method of manufacturing a sliding member described in [17] or [18], a content of the carbon material in the resin composition is approximately 5% by mass or more and approximately 70% by mass or less.

[20] In the method of manufacturing a sliding member described in any one of [17] to [19], the base body has an inner pore, and the method further includes impregnating the inner pore with lubricating oil.

[21] In the method of manufacturing a sliding member described in any one of [17] to [20], the base body has an open porosity of approximately 5% or more and approximately 50% or less.

[22] In the method of manufacturing a sliding member described in any one of [17] to [21], the base body has a surface porosity of approximately 10% or more and approximately 50% or less.

[23] In the method of manufacturing a sliding member described in [18], the housing portion of the base body has an inner surface having a surface porosity of approximately 10% or more and approximately 50% or less.

[24] In the method of manufacturing a sliding member described in any one of [17] to [23], the carbon material is at least one selected from the group consisting of a carbon nano fiber, carbon black and graphite.

### Advantageous Effects of Invention

According to the present invention, it becomes possible to provide a sliding member that can be improved in working efficiency and processing cost for manufacturing the sliding member. Also according to the present invention, it becomes possible to provide a sliding member that can be improved in working efficiency and processing cost for manufacturing the sliding member and also that is reduced in probability that a solid lubricant may fall off from a base body of the sliding member during use of the sliding member.

### BRIEF DESCRIPTION OF DRAWINGS

FIG. 1(a) is a front view of a sliding member manufactured according to the first embodiment of the present invention, and FIG. 1(b) is a cross-sectional view taken along a line B-B in FIG. 1(a)

FIG. 2 is a front view of a base body.

FIG. 3 is a cross-sectional view of a mold showing the state in which the base body and the lubricating member are insert-molded.

FIG. 4 is a plan view of a fixed mold of the mold as seen from a direction C in FIG. 3.

FIG. 5 is a front view of a sliding member manufactured according to another embodiment of the present invention.

### DESCRIPTION OF EMBODIMENTS

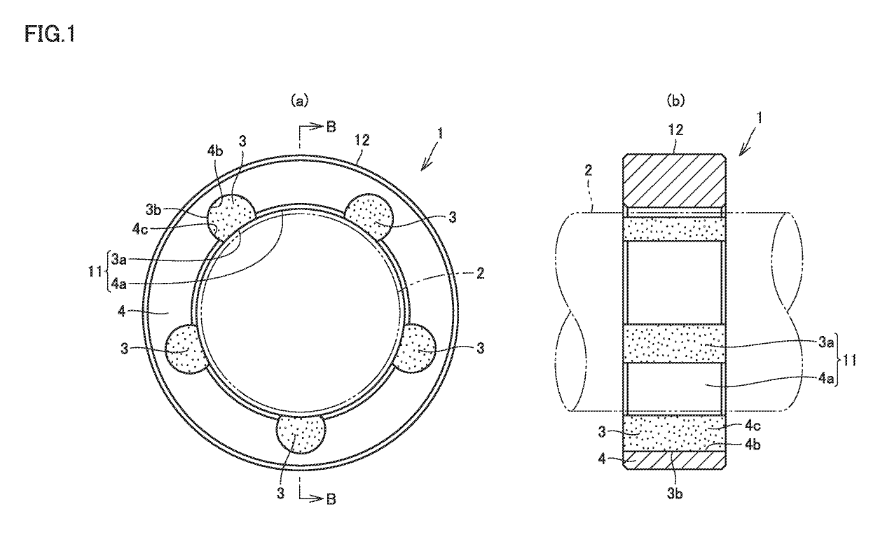

Referring to FIGS. 1(a) and 1(b), a sliding member 1 is formed in a cylindrical shape and has an inner circumference into which a shaft 2 (indicated by a dot-and-dash line) as a mating material is inserted. Sliding member 1 includes: a base body 4 having an inner circumferential surface 4a and a mating face 4b that is formed in a recessed cylindrical surface shape; and a lubricating member 3 disposed in a housing portion 4c of base body 4 and having an inside surface 3a exposed to the inner circumferential surface and an outside surface 3b in close contact with mating face 4b of base body 4. As shown in FIG. 1(a), inside surface 3a of each lubricating member 3 and inner circumferential surface 4a of base body 4 can constitute a bearing surface portion 11 having an exact circular cross-sectional shape, for example. Outer circumferential surface 12 of bearing 1 is fixed to the inner circumferential surface of the housing (not shown) by such means as press fitting, bonding or the like. Also, shaft 2 inserted into the inner circumference of bearing 1 is rotatably supported. In addition to the state where shaft 2 is disposed so as to rotate, shaft 2 can also be disposed so as to be stationary while bearing 1 can also be disposed so as to rotate. Although FIG. 1(a) shows a configuration in which five lubricating members 3 are provided, the number of lubricating members 3 is not limited thereto, but at least a part of the sliding surface may be formed of the surface of lubricating member 3.

In the following, the sliding member according to the present invention will be described in detail with reference to the embodiments.

### First Embodiment

The sliding member according to the present embodiment includes: a base body 4 obtained by compression-molding raw material powder containing metal powder using a forming mold and heating a compact (a metal powder compact) so as to be sintered; and lubricating member 3 obtained as a resin composition disposed as an injection molded product in housing portion 4c of base body 4 by injection-molding a resin composition containing a polyarylene sulfide-based resin and a carbon material using base body 4 as an insert component. Preferably, the polyarylene sulfide-based resin is a main component of the resin composition (the component of the heaviest weight ratio).

In the following, a bearing will be described as an example of the sliding member according to the present invention with reference to FIGS. 1 to 4.

(1) Base Body 4

Referring to FIG. 1, base body 4 is a sintered body obtained by sintering the compact containing metal powder according to the normal manufacturing step employed when manufacturing a bearing. Base body 4 includes housing portion 4c in which lubricating member 3 is to be housed. The compact containing metal powder can be obtained by using a mold to compression-mold raw material powder containing metal powder as a main component (the component of the highest weight ratio), for example. By heating and sintering the compact (metal powder compact) obtained by compression molding, base body 4 including housing portion 4c in which lubricating member 3 is to be housed can be obtained.

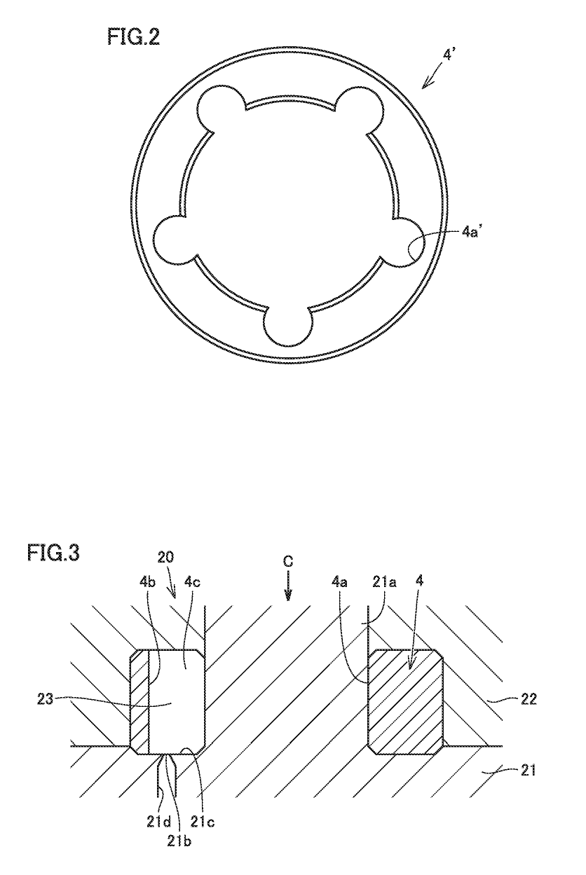

Referring to FIG. 2, raw material powder is introduced into a forming mold and compressed therein, thereby molding a compact 4′ (a metal powder compact) having a shape corresponding to base body 4. A recessed portion 4a′ corresponding to housing portion 4c of base body 4 is formed in metal powder compact 4′ during its molding.

Then, metal powder compact 4′ is heated at a sintering temperature required for sintering this metal powder compact 4′ (for example, approximately 750° C. to 900° C. when metal powder compact 4′ is made of a copper-iron-based material), thereby sintering metal powder compact 4′.

Sintered metal powder compact 4′ is shifted to the sizing step for correcting the dimensions, in which the dimensions of each surface (the inner circumferential surface, the outer circumferential surface and both end faces) are corrected by re-compression inside the mold. In this case, by correcting at least the dimensions of inner circumferential surface 4a that is to be formed as a part of bearing surface portion 11, bearing surface portion 11 having high roundness can be obtained. Thereby, the stabilized bearing performance can be achieved. In this way, bearing surface portion 11 is finally finished in the sizing step, and base body 4 including housing portion 4c in which lubricating member 3 is to be housed can be obtained.

Examples of metal powder used for manufacturing base body 4 can be metal powder of any type of metal such as: copper-based metal containing copper as a main component (the component of the highest weight ratio); iron-based metal containing iron as a main component (the component of the highest weight ratio); and copper-iron-based metal containing copper and iron as main components (the components of the highest weight ratio). In addition, metal powder made of special metal such as aluminum-bronze-based metal can also be used.

When copper-iron-based metal powder is used, metal powder containing a mixture of iron powder, copper powder and low-melting-point metal powder can be used. Low-melting-point metal is a component that melts during sintering to cause liquid-phase sintering to progress. Metal that is lower in low melting point than copper is used as this low-melting-point metal. Specifically, metal that can be used may be metal having a melting point of 700° C. or lower such as metal containing tin (Sn), zinc (Zn) or phosphorus (P), for example. Among others, it is preferable to use tin that is compatible with copper. As to the low-melting-point metal, powder made of this metal alone can be added to mixed powder, and also, this low-melting-point metal alloyed with other metal powder can be added.

In addition to metal powder as described above, sintering aids such as calcium fluoride and lubricants such as zinc stearate can be added as required, and further, graphite powder such as solid lubricant powder can also be added. By adding graphite powder, graphite particles can be dispersed in the sintering structure of sintered base body 4. Accordingly, the lubricity in the portion of bearing surface portion 11 that is formed of base body 4 can be improved.

In this case, specifically, metal (element) constituting base body 4 is formed in proportion of Fe powder, Cu powder and Sn powder that are mixed as powder materials, for example, with which graphite powder is further mixed in the present embodiment. Each powder is blended, for example, in the following ratio of: Cu powder of approximately 10 to 30% by mass, and specifically 10 to 30% by mass (preferably approximately 15 to 20% by mass, and specifically 15 to 20% by mass); Sn powder of approximately 0.5 to 3.0% by mass, and specifically 0.5 to 3.0% by mass (preferably approximately 1.5 to 2.0% by mass and specifically 1.5 to 2.0% by mass); graphite powder of approximately 0.5 to 7.0% by mass, and specifically 0.5 to 7.0% by mass (preferably approximately 0.5 to 3.0% by mass, and specifically 0.5 to 3.0% by mass); and a remainder including Fe powder. The blending ratio of Cu powder is set to fall within the above-described range since the slidability of inner circumferential surface 4a of sliding surface portion 11 decreases when the blending ratio is too low, but problems may occur in the wear resistance of inner circumferential surface 4a of sliding surface portion 11 when the blending ratio is too high.

Sn powder is blended for forming a Cu—Sn alloy structure used for coupling Fe structures of base body 4 to each other by melting Cu powder when compact 4′ (green compact) is sintered. Thus, when the blending amount of Sn powder is too small, the strength of base body 4 cannot be sufficiently increased. However, when the blending amount of Sn powder is too large, base body 4 may be increased in cost. In view of the above, the blending ratio of Cu powder and Sn powder is set to fall within the above-described range.

Furthermore, graphite powder is blended for causing this graphite powder to remain as free graphite in base body 4 to thereby allow this graphite powder to function as a solid lubricant in base body 4. Thus, when the blending ratio of graphite powder is too low, the effect of this graphite powder functioning as a solid lubricant is decreased. However, when the blending ratio of graphite powder is too high, segregation of powder, deterioration of fluidity and deterioration of powder filling performance are caused since graphite is lower in specific gravity than Fe and Cu.

Accordingly, the blending ratio of graphite powder is set to fall within the above-described range.

(2) Lubricating Member 3

In order to dispose lubricating member 3 in housing portion 4c of base body 4, a resin composition containing a polyarylene sulfide-based resin and a carbon material is injection-molded using base body 4 as an insert component. Thereby, a plurality of lubricating members 3 are integrated with base body 4. More specifically, a plurality of lubricating members 3 are disposed as injection molded products in housing portions 4c of base body 4 (which will be hereinafter also referred to as an insert molding step).

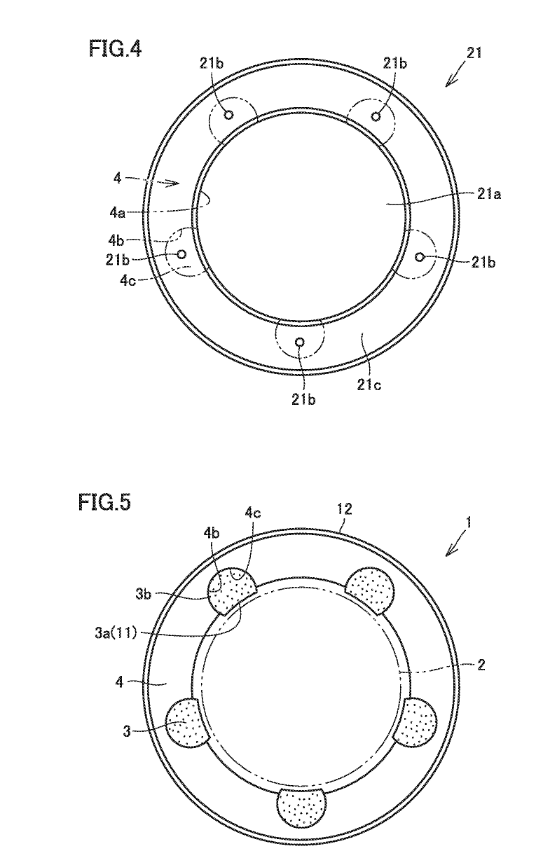

Referring to FIG. 3, the insert molding step can be performed by using a forming mold 20 including a fixed mold 21 and a movable mold 22. Fixed mold 21 is provided with a circular cylindrical portion 21a. Inner circumferential surface 4a of base body 4 is formed along the outer circumferential surface of circular cylindrical portion 21a. Fixed mold 21 includes a molding surface 21c along which the end face of lubricating member 3 is formed. This molding surface 21c is provided with a gate 21b. In the present embodiment, a plurality of (in the shown example, five) gates 21b are arranged at regular intervals in the circumferential direction on molding surface 21c of fixed mold 21 (see FIG. 4). The type of gate is not limited to a point-shaped gate as in the shown example, but may be an annular-shaped film gate, for example.

In the insert molding step, base body 4 is first inserted into circular cylindrical portion 21a of fixed mold 21 and disposed therein. In this state, movable mold 22 and fixed mold 21 are clamped, thereby forming a cavity 23. At this time, base body 4 is sandwiched from both sides in the axial direction between fixed mold 21 and movable mold 22. This cavity 23 corresponds to housing portion 4c of base body 4.

Then, a resin composition containing a polyarylene sulfide-based resin and a carbon material is injected from a runner 21d through gate 21b into cavity 23. Thereby, cavity 23 is filled with a melted resin composition. The resin composition introduced into cavity 23 is cooled and hardened, so that lubricating member 3 is disposed in inner circumferential surface 4a of base body 4, thereby fabricating bearing 1.

According to the above-described embodiment, for example, a resin composition containing a polyarylene sulfide-based resin, which is a thermoplastic resin, as a main component (the component of the highest weight ratio) and further containing a carbon material is injected into housing portion 4c Thereby, bearing 1 having lubricating member 3 disposed in housing portion 4c can be manufactured efficiently and continuously in large quantity. Since bearing 1 can be manufactured efficiently and continuously in large quantity, each bearing 1 can be manufactured at reduced cost. Furthermore, lubricating member 3 is disposed in housing portion 4c of base body 4. Thus, due to the anchor effect of the polyarylene sulfide-based resin contained in lubricating member 3, the coupling strength between base body 4 and lubricating member 3 is increased on mating face 4b (the inner surface of housing portion 4c). Thereby, it becomes possible to reduce the risk of falling-off of lubricating member 3 from base body 4 of bearing 1 during use of bearing 1.

(3) Polyarylene Sulfide-Based Resin

The polyarylene sulfide-based resin (which will be hereinafter referred to as a PAS resin) used in the invention of the present application is a synthetic resin generally represented by the following general formula (1). Ar in the following general formula (1) is an allylene group. Examples of Ar may be represented by the following general formulae (2) to (7).

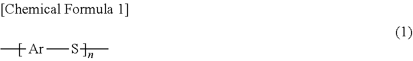

[n is a natural number representing the repeating number of the repeating unit “—Ar—S—”.]

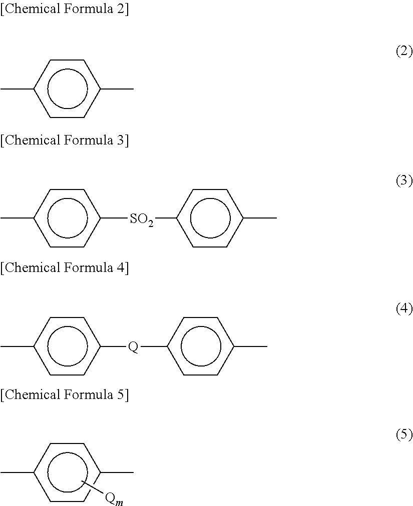

[Q represents CH₃ or halogen that is selected from F, Cl and Br, and m represents integers of 1 to 4.]

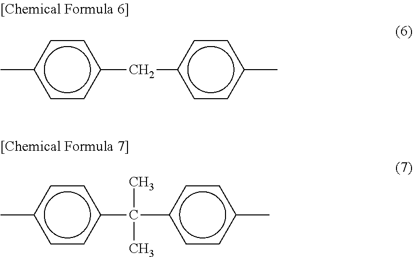

As the PAS resin used in the invention of the present application, a polyphenylene sulfide resin (which will be hereinafter referred to as a PPS resin) represented by the above-described general formula (1) including the above-described general formula (2) in place of Ar can be suitably used.

As to the PAS resin, the content of the repeating unit (—Ar—S—) is preferably 70 mol % or more and more preferably 90 to 100 mol %. The content of the repeating unit used herein means the proportion of the repeating unit occupied in 100% of the total monomers constituting a PAS resin. When the PAS resin exhibiting the content of the repeating unit less than 70 mol % is used, it is less likely to achieve the stability such as reduction in dimensional change in lubricating member 3 based on low absorptivity when lubricating member 3 is formed.

A PAS resin can be obtained by using already well-known methods. For example, the PAS resin is synthesized by: the reaction between a halogen-substituted aromatic compound and alkali sulfide as disclosed in Japanese Patent Publication No. 44-27671 and Japanese Patent Publication No. 45-3368; the condensation reaction between an aromatic compound and a sulfur chloride under Lewis acid catalyst coexistence as disclosed in Japanese Patent Publication No. 46-27255; the condensation reaction of thiophenols under coexistence of an alkali catalyst, copper salt or the like as disclosed in U.S. Pat. No. 3,274,165; or the like, but a specific method can be optionally selected in accordance with intended purposes.

Examples of specific methods may be causing sodium sulfide and p-dichlorobenzene to react in an amide-based solvent such as N-methyl pyrrolidone and dimethylacetamide or a sulfone-based solvent such as sulfolane. In addition, the components represented by the following general formulae (8) to (12) are contained in the PAS resin, for example, in the range in which the crystallinity of the PAS resin is not influenced, thereby producing a copolymerized component. The addition amount of the component represented by each of the following general formulae (8) to (12) can be set to be less than 30 mol %, preferably less than 10 mol % and 1 mol % or more with respect to 100% of the total monomers constituting a PAS resin.

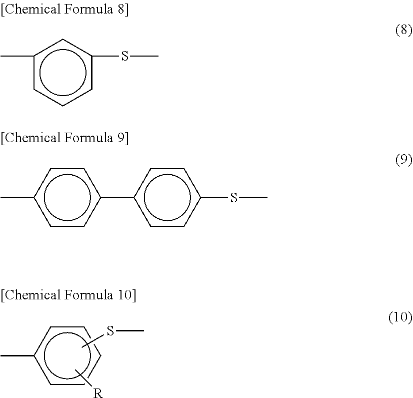

[R represents an alkyl group other than a methyl group, a nitro group, a phenyl group, an alkoxy group, and the like.]

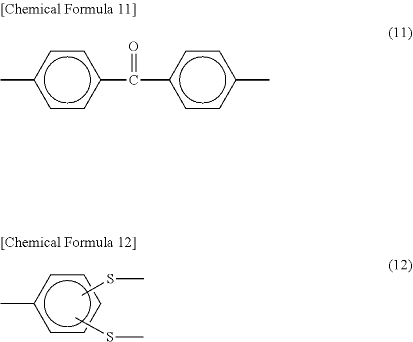

Furthermore, it is preferable that the PAS resin is a crosslink type or has a partial crosslink coupling, that is, a partial crosslink. The PAS resin having a partial crosslink coupling is also referred to as a semi-crosslink type or semi-linear type PAS. The crosslink-type PAS resin allows the molecular weight of polymer to be increased to the required level by conducting a heat treatment under existence of oxygen during the step of manufacturing a polymer. The crosslink-type PAS resin includes polymer molecules, some of which constitute a two-dimensional or three-dimensional crosslink structure formed mutually through oxygen. Accordingly, high rigidity can be kept even under a high temperature environment as compared with the linear-type PAS resin as described below, so that the crosslink-type PAS resin is excellent since it is reduced in creep deformation and is less likely to be stress-relaxed. In this way, the crosslink type or semi-crosslink-type PAS resin is excellent in heat resistance, creep resistance and wear resistance as compared with the linear-type (non-crosslink type) PAS resin. This results in an advantage that burrs occur less in the injection molded product than the linear-type PAS resin.

On the other hand, the linear-type PAS resin does not undergo a heat treatment step in the polymer manufacturing step. Thus, no crosslink structure is included in each polymer molecule, but molecules are formed in a one-dimensional straight-chain shape. Generally, the linear-type PAS resin is characterized in that it is lower in rigidity and slightly higher in toughness and extensibility than a crosslink-type PAS resin. Furthermore, the linear-type PAS resin is excellent in mechanical strength from a specific direction. Also, the linear-type PAS resin exhibits high polymer purity and absorbs less moisture, which leads to an advantage that the dimensional changes are further reduced and the deterioration of the electric insulation performance is also reduced even in a high temperature and humidity atmosphere. Furthermore, the linear-type PAS resin can be reduced in melt viscosity, for example, by adjusting the molecular weight. Thus, it becomes possible to avoid reduction in yield rate during injection molding due to reduction in fluidity of the resin composition made of a linear-type PAS resin mixed with a large amount of carbon materials and the like, and also avoid difficulty in performing injection molding.

Examples of the method of forming a crosslink or a partial crosslink coupling in the PAS resin may be: a method of polymerizing polymers with low degree of polymerization and heating the polymerized polymers in the atmosphere containing air; and a method of adding a crosslink agent or a branching agent.

It is preferable that the apparent melt viscosity of the PAS resin is set to fall within the range of 1000 poises or more and 10000 poises or less. When the apparent melt viscosity is too low, the strength of lubricating member 3 may deteriorate. In contrast, when the apparent melt viscosity is too high, the moldability may decrease and the melted resin material is less likely to come into open pores on the surface of base body 4. This may reduce the anchor effect.

The melt viscosity of the crosslink-type PAS resin can be set to be 1000 poises to 5000 poises, and preferably 2000 poises to 4000 poises. When the melt viscosity is too low, the mechanical characteristics such as creep resistance may be lowered in an area of high temperature of 150° C. or higher. When the melt viscosity is too high, the moldability may deteriorate. The melt viscosity can be measured by a Koka-type flow tester under conditions of: a measurement temperature of 300° C., an orifice having a hole diameter of 1 mm; a length of 10 mm; a measurement load of 20 kg/cm², and a pre-heating time of 6 minutes.

Furthermore, for the thermal stability of the PAS resin having partial crosslink coupling, it is preferable that the change rate of the melt viscosity at 6 minutes and 30 minutes after pre-heating falls within the range of −50% to −150% under the above-described melt viscosity measurement condition. The change rate is represented by the following equation.

[Change rate=(P30−P6)/P6×100(P6:measured value at 6 minutes after pre-heating,P30:measured value at 30 minutes after pre-heating)].

Examples of the PAS resin having a partial crosslink coupling satisfying the above-described conditions may be T4, T4AG, TX-007 and the like manufactured by Tohpren.co.jp. The weight average molecular weight of the PAS resin is preferably 20000 to 45000 and more preferably 25000 to 40000. When the weight average molecular weight is less than 20000, the heat resistance tends to decrease. When the weight average molecular weight is greater than 45000, the moldability relative to the complicated and precise dimensional accuracy tends to decrease. The weight average molecular weight in the present invention means the weight average molecular weight in polystyrene conversion measured by a gel permeation chromatography method (GPC method) after the PAS resin is dissolved in a solvent. This measurement is performed on the conditions shown in the example described later.

Furthermore, the molecular weight of the PAS resin is preferably 13000 to 30000 in number average molecular weight in consideration of the injection moldability, and more preferably 18000 to 25000 in number average molecular weight further in consideration of the fatigue resistance and high molding accuracy. When the number average molecular weight is less than 13000, the fatigue resistance tends to decrease since the molecular weight is too small. In contrast, when the number average molecular weight is greater than 30000, the fatigue resistance is improved but carbon fibers may need to be contained, for example, in order to achieve the mechanical strength such as required impact strength. For example, when carbon fibers of 10 to 50% by mass are contained, the melt viscosity during molding exceeds the above-described upper limit value (10000 poises). Thus, the molding accuracy of lubricating member 3 tends to be difficult to be ensured during injection molding. In addition, the number average molecular weight in the present invention means the number average molecular weight in polystyrene conversion measured by a gel permeation chromatography method (GPC method) after the PAS resin is dissolved in a solvent. This measurement is performed on the conditions shown in the example described later.

The melting point of the PAS resin is approximately 220° C. to 290° C., and preferably 280° C. to 290° C., for example. Since the melting point of the PPS resin is generally approximately 285° C., it is preferable to use a PPS resin as a PAS resin. Furthermore, the PAS resin is low in absorptivity. Thus, lubricating member 3 containing a PAS resin tends to be reduced in dimensional change by water absorption.

Accordingly, bearing 1 including lubricating member 3 containing a PAS resin tends to have excellent stability that seizure in lubricating member 3 is less likely to occur and the dimensional change by water absorption is reduced.

(4) Carbon Material

Examples of the carbon material blended with a resin composition may be graphite, a carbon nano fiber, carbon black, and the like. The carbon material may be formed in powder state. Carbon material powder can be prepared, for example, using graphite powder, and specifically, natural graphite powder and artificial graphite powder both can be used. Natural graphite powder has a scale shape, so that it has a characteristic of being excellent in lubricity. On the other hand, artificial graphite powder has a massive shape, so that it has a characteristic of being excellent in moldability. In addition, carbon material powder can be prepared using not only graphite powder as crystalline powder but also using amorphous powder such as pitch powder and coke breeze. When carbon nano fibers are used as a carbon material, the mechanical strength such as a bending elastic modulus of lubricating member 3 can be improved. Carbon nano fibers are classified roughly into a pitch-based type and a PAN-based type, both of which can be used. A carbon nano fiber having an average fiber diameter of 20 μm or less and an average fiber length of 0.02 mm to 0.2 mm can be used, for example.

A binder can also be contained in the carbon material powder (for example, graphite powder). Resin binder powder can be used as a binder while phenol resin powder can be used as resin binder powder, for example. It is preferable that a molding assistant, a lubricant, a modifier or the like is added as required to uniformly mix the carbon material powder with the binder.

Examples of raw material powder constituting lubricating member 3 may be a powder mixture of carbon material powder and resin binder powder as described above, and also, granulated powder obtained by granulating carbon material powder through intervention of the resin binder. Granulated powder is higher in specific gravity and fluidity than resin binder powder alone or carbon material powder alone. Thus, the resin composition containing granulated powder can be readily supplied to a forming mold, and can be molded into a prescribed shape with excellent accuracy.

In bearing 1, lubricating member 3 constituting a part of bearing surface portion 11 serves as a supply source of a carbon material. The carbon material supplied from lubricating member 3 is spread throughout bearing surface portion 11 by the relative movement of bearing surface portion 11 and shaft 2. Thereby, the lubrication effect by the carbon material can be achieved throughout bearing surface portion 11.

(5) Other Materials

The resin composition may contain other filler materials in addition to a polyarylene sulfide-based resin and a carbon material. Examples of other filler materials may be: fibers such as a glass fiber, an aramid fiber, an alumina fiber, an aromatic polyamide fiber, a polyester fiber, a boron fiber, a silicon carbide fiber, a boron nitride fiber, a silicon nitride fiber, and a metal fiber, and fibers knitted in a cloth shape; minerals such as calcium carbonate, talc, silica, clay, and mica; inorganic whiskers such as an aluminum borate whisker and a potassium titanate whisker; and various types of heat resistant resins such as a polyimide resin and polybenzimidazole. By containing these filler materials, the frictional wear characteristics of lubricating member 3 can be improved while the coefficient of linear expansion can be reduced. Also, additive agents such as a release agent, a flame retardant, a weather resistance modifier, an antioxidant, and a pigment may be appropriately added as required.

(6) Content of Carbon Material

The content of the carbon material blended with the resin composition is set to fall within a suitable range in order to ensure the sliding characteristics of the sliding surface of lubricating member 3. The content of the carbon material is set to be: approximately 5% by mass or more and approximately 70% by mass or less, specifically 5% by mass or more and 70% by mass or less, preferably approximately 10% by mass or more and approximately 60% by mass or less, specifically 10% by mass or more and 60% by mass or less, more preferably approximately 40% by mass or less, and specifically 40% by mass or less. In the case where the blending amount of the carbon material in the resin composition is less than approximately 5% by mass, specifically less than approximately 10% by mass, and more specifically less than 10% by mass, the blending amount of carbon material is relatively small, so that the effect of improving the sliding characteristics of the sliding surface by the carbon material tends to be hardly achieved. In the case where the blending amount of the carbon material in the resin composition is more than approximately 70% by mass, specifically more than approximately 60% by mass, and more specifically more than 60% by mass, the fluidity of the resin composition is reduced to thereby reduce the yield rate during injection molding, and also, injection molding tends to be difficult to be performed. In order to avoid reduction in yield rate during injection molding while ensuring the sliding characteristics, the content of the carbon material blended into the resin composition is preferably set to fall within the above-described range, and more preferably approximately 40% by mass or less and specifically 40% by mass or less.

(7) Impregnation with Lubricating Oil

Bearing 1 has numberless inner pores. Thus, the inner pores in bearing 1 having undergone the insert molding step can be impregnated with lubricating oil. For example, after bearing 1 having undergone the insert molding step is immersed in the lubricating oil under a decompression environment, the decompressed pressure is returned to atmospheric pressure, so that the inner pores in bearing 1 can be impregnated with lubricating oil. Lubricating oil is not particularly limited as long as it is commonly used for a bearing, and for example, may be: mineral oil such as spindle oil, refrigeration oil, turbine oil, machine oil, and dynamo oil; hydrocarbon-based synthetic oil such as polybutene, poly-α-olefin, alkyl naphthalene, and an alicyclic compound; or ester such as ester oil of natural oil/fat and polyol, phosphate ester, and diester oil; non-hydrocarbon-based synthetic oil such as polyglycol oil, silicone oil, polyphenylether oil, alkyldiphenyl ether oil, alkylbenzene, and fluorinated oil; liquid grease; or the like.

(8) Open Porosity of Base Body 4

The open porosity of base body 4 is set to fall within a suitable range in order to improve the sliding characteristics of bearing 1 by the lubricating oil functioning as a lubricity imparting agent in the case where each inner pore in bearing 1 having undergone the insert molding step is impregnated with this lubricating oil. The open porosity of base body 4 is approximately 5% or more, specifically 5% or more, preferably approximately 10% or more, specifically 10% or more, more preferably approximately 15% or more, and specifically 15% or more. Furthermore, the open porosity of base body 4 is approximately 50% or less, specifically 50% or less, preferably approximately 40% or less, specifically 40% or less, more preferably approximately 30% or less, specifically 30% or less, further more preferably approximately 25% or less, and specifically 25% or less. When the open porosity is less than approximately 5% (specifically 5%), the total amount of the lubricating oil with which each inner pore in base body 4 is impregnated is relatively small. This leads to a tendency that it becomes difficult for bearing 1 to achieve excellent lubrication performance based on the lubricating oil for a long period of time. Furthermore, when the open porosity is greater than approximately 50% (specifically 50%), base body 4 is difficult to be molded, so that the moldability of base body 4 decreases. As a result, it becomes difficult to mold base body 4 with excellent productivity. Thus, production of bearing 1 including base body 4 at low cost tends to be difficult. In order to mold bearing 1 with excellent productivity while allowing base body 4 to exhibit its excellent lubrication performance with the help of lubricating oil, it is preferable that the open porosity of base body 4 falls within the above-described range. In addition, the “open porosity” represents the percentage of the inner pores, which can be impregnated, with respect to the volume of base body 4 and is calculated by dividing the volume of oil after complete impregnation by the volume of base body 4 and multiplying the divided result by 100. The open porosity can be measured by “Sintered metal materials-Determination of density, oil content and open porosity (JIS Z 2501: 2000)” defined by the Japanese Industrial Standards.

(9) Oil Content in Base Body 4

The inner pores in this base body 4 are impregnated with lubricating oil such as mineral oil or synthetic oil, for example, as a lubricant. Thus, when base body 4 rotates with respect to shaft 2, the lubricating oil kept in the inner pores in base body 4 exudes from the surface pores on inner circumferential surface 4a of base body 4, thereby forming an oil film of lubricating oil between inner circumferential surface 4a (sliding surface portion 11) and the outer circumferential surface of shaft 2. Thereby, wear of sliding surface portion 11 is suppressed or prevented. The oil content in the entire base body 4 is set to be approximately 5 vol % or more, specifically 5 vol % or more, preferably approximately 10 vol % or more, specifically 10 vol % or more, more preferably approximately 15 vol % or more, and specifically 15 vol % or more. Furthermore, the oil content in the entire base body 4 is set to be approximately 50 vol % or less, specifically 50 vol % or less, preferably approximately 40 vol % or less, specifically 40 vol % or less, more preferably approximately 30 vol % or less, specifically 30 vol % or less, further more preferably approximately 25 vol % or less, and specifically 25 vol % or less. When the oil content is less than approximately 5 vol %, specifically approximately 10 vol %, more specifically approximately 15 vol %, and further more specifically 15 vol %, the desired lubrication characteristics cannot be stably maintained and exhibited for a long period of time. This is because, when the oil content is more than approximately 50 vol %, specifically approximately 40 vol %, more specifically approximately 30 vol %, further more specifically approximately 25 vol %, and particularly specifically 25 vol %, the inner porosity is increased, so that the mechanical strength required for the entire base body 4 may not be able to be ensured.

At too low viscosity of the lubricating oil with which the inner pores in base body 4 are impregnated, the lubricating oil is more likely to flow to the outside and the oil film rigidity is reduced, so that the effect of suppressing wear of sliding surface portion 11 may be insufficient. On the other hand, at too high viscosity of the lubricating oil, the amount of lubricating oil exuding from the surface pores in sliding surface portion 11 is insufficient, so that the oil film having prescribed thickness and rigidity may not be able to be formed. From the above-described point of view, the kinematic viscosity of the lubricating oil at 40° C. is set to be approximately 5 mm²/s or more, specifically 5 mm²/s or more, preferably approximately 30 mm²/s or more, specifically 30 mm²/s or more, more preferably approximately 50 mm²/s or more, and specifically 50 mm²/s or more. Also, the kinematic viscosity of the lubricating oil at 40° C. is set to be approximately 600 mm²/s or less, specifically 600 mm²/s or less, preferably approximately 550 mm²/s or less, specifically 550 mm²/s or less, more preferably approximately 500 mm²/s or less, and specifically 500 mm²/s or less.

In addition, the inner pores in base body 4 may be impregnated with liquid grease in place of the above-described lubricating oil. Examples of liquid grease may be grease obtained by adding a soap-based thickening agent such as lithium soap or a non-soap-based thickening agent such as urea to the lubricating oil, as base oil, having kinematic viscosity falling within the above-described range at 40° C.

(10) Surface Porosity of Base Body 4

The surface porosity in mating face 4b as an inner surface of housing portion 4c in base body 4 is set to fall within a suitable range in order to enhance the coupling strength between base body 4 and lubricating member 3 by the anchor effect of the polyarylene sulfide-based resin contained in lubricating member 3 disposed in housing portion 4c of base body 4. The surface porosity is preferably 10% or more and 50% or less. When the surface porosity is less than 10%, the amount of polyarylene sulfide-based resin contained in lubricating member 3 and flowing into the surface pores in mating face 4b is reduced. Accordingly, the anchor effect of the polyarylene sulfide-based resin tends to decrease. Furthermore, when the surface porosity is more than 50%, molding of housing portion 4c tends to be difficult. It is preferable that the surface porosity of base body 4 falls within the above-described range in order to mold bearing 1 with excellent productivity while enhancing the coupling strength between base body 4 and lubricating member 3. The “surface porosity” means the proportion (area ratio) of the total area of the surface pores per surface unit area. Also, the surface porosity used herein can be obtained, for example, by calculating the area of the pore portion using the image taken by a metallographic microscope such as ECLIPSE ME600 manufactured by Nikon Corporation (for example, 500 times magnification) and captured as image date in a computer, for the sake of convenience.

(11) Material of Shaft 2

The material of the shaft is not particularly limited, and the shaft can be formed using various materials such as SS steel, S-C steel, SCM steel, SUJ steel, and SUS steel. The hardness of steel may be approximately HRC30 to HRC60 (HB286 to HB654), or may be approximately HB140 to HB220. Also, the hardness after the quenching process may be approximately HRC55 to HRC70, preferably HRC55 to HRC60, or approximately HRC60 to HRC65. In this way, a plain bearing apparatus including sliding member 1 and shaft 2 may be fabricated.

The above embodiment has been described with regard to the configuration in which inside surface 3a of lubricating member 3 and inner circumferential surface 4a of base body 4 are arranged in the same cylindrical surface shape to form bearing surface portion 11, but the present invention is not limited thereto. In the following, other embodiments of the present invention will be described, but the same description as those of the above-mentioned embodiments will not be repeated.

### Other Embodiments

Referring to FIG. 5, bearing 1 may be manufactured in such a manner that inside surface 3a of lubricating member 3 is disposed on the inner diameter side of inner circumferential surface 4a of base body 4 so as to form bearing surface portion 11 only using inside surface 3a of lubricating member 3. In this case, it is preferable that inside surfaces 3a of the plurality of lubricating members 3 are disposed on the same cylindrical surface.

Furthermore, lubricating member 3 may be disposed over the entire length of bearing 1 in the axial direction as shown in FIG. 1(b), and additionally, may be disposed only along a partial region in the axial direction or may be disposed at a plurality of positions spaced apart from each other in the axial direction, for example.

Furthermore, in bearing 1, shaft 2 does not necessarily have to slide along the entire bearing surface portion 11, but a limited partial region of bearing surface portion 11 may slide along shaft 2, for example. Specifically, when shaft 2 is positioned in the horizontal posture, shaft 2 may fall with gravity and slide along bearing surface portion 11 in the lower region of bearing surface portion 11. In this case, the position and the shape of lubricating member 3 in bearing 1 are designed or the phase of bearing 1 in the circumferential direction is adjusted such that lubricating member 3 is located in the region where this lubricating member 3 slides along shaft 2. Thereby, shaft 2 can always slide along lubricating member 3. Thus, a high lubrication effect can be achieved. Accordingly, shaft 2 can be supported, for example, in the oil-less state in which no lubricating oil is interposed between shaft 2 and bearing surface portion 11. As a matter of course, the lubricating oil interposed between bearing surface portion 11 and shaft 2 can also be employed. In this case, the lubrication effect is further enhanced. In the present embodiment, lubricating oil is interposed between bearing surface portion 11 and shaft 2 while the inner pores in substrate 4 are impregnated with oil. In this case, oil exudes from the surface (inside surface 3a) of substrate 4 due to the increased temperature in accordance with rotation of shaft 2. Then, this oil is supplied to the sliding region between bearing surface portion 11 and shaft 2. Thereby, cutting-off of the oil film in the sliding region is reliably avoided, so that excellent slidability is maintained.

Furthermore, the present invention is applicable not only to the bearing configured to support the relative rotation of the shaft but also to the bearing configured to support the axial movement of the shaft. Also, the present invention is applicable not only to a sliding member having a cylindrical shape but also to a sliding member having other shapes (for example, a semi-cylindrical shape or a rectangular parallelepiped shape).

In the following, the sliding member according to the present invention and the method of manufacturing the same will be described in detail with reference to embodiments.

### Second Embodiment

The sliding member manufactured by the manufacturing method according to the present embodiment is a sliding member as described below.

A sliding member having a sliding surface that is at least partially formed of a surface of a lubricating member is provided. The sliding member includes: a base body as a sintered body of a compact containing metal powder, the base body being integrated with the lubricating member; and the lubricating member as an injection molded product of a resin composition containing a thermoplastic resin and a carbon material.

The method of manufacturing the sliding member according to the present embodiment is a method of manufacturing a sliding member having lubricating member 3 disposed in housing portion 4c of base body 4 by utilizing injection molding. The method includes the steps of: compression-molding raw material powder containing metal powder as a main component (the component of the highest weight ratio) using a forming mold, and heating and sintering a compact (a metal powder compact), thereby obtaining base body 4 (the base body manufacturing step), and injection-molding the resin composition containing a carbon material and a thermoplastic resin using base body 4 as an insert component, thereby disposing the resin composition as lubricating member 3 in housing portion 4c of base body 4 (the insert molding step). The above-described steps are included in the above-mentioned order in the manufacturing method.

In the following, each of the steps will be described with regard to the bearing as an example of the sliding member according to the present invention with reference to FIGS. 1 to 4.

(1) Base Body Manufacturing Step

Referring to FIG. 1, the present step includes the step of sintering a compact containing metal powder according to the normal manufacturing step employed when manufacturing a bearing, thereby manufacturing base body 4 including housing portion 4c in which lubricating member 3 is to be housed. The compact containing metal powder can be obtained, for example, by compression-molding raw material powder containing metal powder as a main component (the component of the highest weight ratio) using a forming mold. The compact (the metal powder compact) obtained by compression molding is heated and sintered, so that base body 4 including housing portion 4c in which lubricating member 3 is to be housed can be obtained.

Referring to FIG. 2, raw material powder is introduced into the forming mold and compressed therein, thereby molding compact 4′ (metal powder compact) having a shape corresponding to base body 4. Recessed portion 4a′ corresponding to housing portion 4c of base body 4 is formed in this metal powder compact 4′ during its molding.

Then, metal powder compact 4′ is heated at a sintering temperature required for sintering metal powder compact 4′ (for example, approximately 750° C. to 900° C. when metal powder compact 4′ is made of a copper-iron-based material), thereby sintering metal powder compact 4′.

Sintered metal powder compact 4′ is shifted to the sizing step for correcting the dimensions, in which the dimensions of each surface (the inner circumferential surface, the outer circumferential surface and both end faces) are corrected by re-compression inside the mold. In this case, by correcting at least the dimensions of inner circumferential surface 4a that is to be formed as a part of bearing surface portion 11, bearing surface portion 11 having high roundness can be obtained. Thereby, the stabilized bearing performance can be achieved. In this way, bearing surface portion 11 is finally finished in the sizing step, and base body 4 including housing portion 4c in which lubricating member 3 is to be housed can be obtained.

Examples of metal powder used for manufacturing base body 4 can be metal powder made of any type of metal such as: copper-based metal containing copper as a main component (the component of the highest weight ratio); iron-based metal containing iron as a main component (the component of the highest weight ratio); and copper-iron-based metal containing copper and iron as main components (the components of the highest weight ratio). In addition, metal powder of special metal such as aluminum-bronze-based metal can also be used.

When copper-iron-based metal powder is used, metal powder containing a mixture of iron powder, copper powder and low-melting-point metal powder can be used. Low-melting-point metal is a component that melts during sintering to cause liquid-phase sintering to progress. Metal that is lower in low melting point than copper is used as this low-melting-point metal. Specifically, metal that can be used may be metal having a melting point of 700° C. or lower such as metal containing tin (Sn), zinc (Zn) or phosphorus (P), for example. Among others, it is preferable to use tin that is compatible with copper. As to the low-melting-point metal, its powder alone can be added to mixed powder, and also, this low-melting-point metal alloyed with other metal powder can be added.

In addition to metal powder as described above, sintering aids such as calcium fluoride and lubricants such as zinc stearate can be added as required, and further, graphite powder as solid lubricant powder can also be added. By adding graphite powder, graphite particles can be dispersed in the sintering structure of sintered base body 4. Accordingly, the lubricity in the portion of bearing surface portion 11 that is formed of base body 4 can be improved.

In this case, specifically, metal (element) constituting base body 4 is formed in proportion of Fe powder, Cu powder and Sn powder that are mixed as a powder material, for example, with which graphite powder is further mixed in the present embodiment. Each powder is blended, for example, in the following ratio of: Cu powder of approximately 10 to 30% by mass, and specifically 10 to 30% by mass (preferably approximately 15 to 20% by mass, and specifically 15 to 20% by mass); Sn powder of approximately 0.5 to 3.0% by mass, and specifically 0.5 to 3.0% by mass (preferably approximately 1.5 to 2.0% by mass and specifically 1.5 to 2.0% by mass); graphite powder of approximately 0.5 to 7.0% by mass and specifically 0.5 to 7.0% by mass (preferably approximately 0.5 to 3.0% by mass and specifically 0.5 to 3.0% by mass), and a remainder including Fe powder. The blending ratio of Cu powder is set to fall within the above-described range since the slidability of inner circumferential surface 4a of sliding surface portion 11 decreases when the blending ratio is too low, but problems may occur in the wear resistance of inner circumferential surface 4a of sliding surface portion 11 when the blending ratio is too high.

Then, Sn powder is blended for forming a Cu—Sn alloy structure used for coupling Fe structures of base body 4 to each other by melting Cu powder when compact 4′ (green compact) is sintered. Thus, when the blending amount of Sn powder is too small, the strength of base body 4 cannot be sufficiently increased. However, when the blending amount of Sn powder is too large, base body 4 may be increased in cost. In view of the above, the blending ratio of Cu powder and Sn powder is set to fall within the above-described range.

Furthermore, graphite powder is blended for causing this graphite powder to remain as free graphite in base body 4 to thereby allow this graphite powder to function as a solid lubricant in base body 4. Thus, when the blending ratio of graphite powder is too low, the effect of this graphite powder functioning as a solid lubricant is decreased. However, when the blending ratio of graphite powder is too high, segregation of powder, deterioration of fluidity and deterioration of powder filling performance are caused since graphite is lower in specific gravity than Fe and Cu. Accordingly, the blending ratio of graphite powder is set to fall within the above-described range.

(2) Insert Molding Step

In the present step, in order to dispose lubricating member 3 in housing portion 4c of base body 4, a resin composition containing a carbon material and a thermoplastic resin is injection-molded using base body 4 as an insert component. Thereby, a plurality of lubricating members 3 are integrated with base body 4. More specifically, in this step, a plurality of lubricating members 3 are disposed in housing portion 4c of base body 4.

Referring to FIG. 3, the present step can be performed by using a forming mold 20 including a fixed mold 21 and a movable mold 22. Fixed mold 21 is provided with a circular cylindrical portion 21a. Inner circumferential surface 4a of base body 4 is formed along the outer circumferential surface of circular cylindrical portion 21a. Fixed mold 21 includes a molding surface 21c that is configured to form the end face of lubricating member 3. This molding surface 21c is provided with a gate 21b. In the present embodiment, a plurality of (in the shown example, five) gates 21b are arranged at regular intervals in the circumferential direction on molding surface 21c of fixed mold 21 (see FIG. 4). The type of gate is not limited to a point-shaped gate as in the shown example, but may be an annular-shaped film gate, for example.

In the insert molding step, base body 4 is first inserted into circular cylindrical portion 21a of fixed mold 21 and disposed therein. In this state, movable mold 22 and fixed mold 21 are clamped, thereby forming a cavity 23. At this time, base body 4 is sandwiched from both sides between fixed mold 21 and movable mold 22. This cavity 23 corresponds to housing portion 4c of base body 4.

Then, a melted resin composition containing a carbon material and a thermoplastic resin is injected from a runner 21d through gate 21b into cavity 23. Thereby, cavity 23 is filled with the melted resin composition. The resin composition introduced into cavity 23 is cooled and hardened, so that lubricating member 3 is disposed in inner circumferential surface 4a of base body 4, thereby fabricating bearing 1.

According to the above-described embodiment, for example, a resin composition containing a thermoplastic resin as a main component (the component of the highest weight ratio) and further containing a carbon material is injected into housing portion 4c. Thereby, bearing 1 having lubricating member 3 disposed in housing portion 4c can be manufacturing efficiently in large quantity. Since bearing 1 can be manufactured in large quantity, each bearing 1 can be manufactured at reduced cost. Furthermore, lubricating member 3 is disposed in housing portion 4c of base body 4. Thus, due to the anchor effect of the thermoplastic resin contained in lubricating member 3, the coupling strength between base body 4 and lubricating member 3 is increased on mating face 4b (the inner surface of housing portion 4c). Thereby, it becomes possible to reduce the risk of falling-off of lubricating member 3 from base body 4 of bearing 1 during use of bearing 1.

Examples of the thermoplastic resin as a main component (the component of the highest weight ratio) of the resin composition may be resins including: a liquid crystal polymer (LCP) such as polyamide (PA), polycarbonate (PC), polybutylene terephthalate (PBT), polyacetal (POM) and a wholly aromatic polyester-based liquid crystal polymer; a fluororesin (a polyfluoro-olefin-based resin) such as a polyarylene sulfide-based resin (which may be polyphenylene sulfide (PPS), for example), polyetheretherketone (PEEK), polyamide-imide (PAI), polyetherimide (PEI), polyimide (PI), polytetrafluoroethylene perfluoro alkyl vinyl ether copolymer (PFA), tetrafluoroethylene hexafluoropropylene copolymer (FEP), ethylene-tetrafluoroethylene copolymer (ETFE); and an olefin-based resin such as polyethylene. Each of these synthetic resins may be used alone or may be a polymer alloy containing a mixture of two or more types of the above-mentioned resins. When the thermoplastic resin contains a polyarylene sulfide-based resin, the sliding member according to the above-described embodiment can be manufactured by the manufacturing method according to the present embodiment.

Examples of the carbon material blended with a resin composition may be graphite, a carbon nano fiber, carbon black, and the like. The carbon material may be formed in powder state. Carbon material powder can be prepared, for example, using graphite powder, and specifically, natural graphite powder and artificial graphite powder both can be used. Natural graphite powder has a scale shape, so that it has a characteristic of being excellent in lubricity. On the other hand, artificial graphite powder has a massive shape, so that it has a characteristic of being excellent in moldability. In addition, carbon material powder can be prepared using not only graphite powder as crystalline powder but also using amorphous powder such as pitch powder and coke breeze.

In order to achieve mechanical strength such as required impact strength, for example, carbon fibers may need to be contained. For example, carbon fibers of 10 to 50% by mass are contained.

When carbon nano fibers are blended as a carbon material, the mechanical strength such as a bending elastic modulus is improved. Also, when carbon material powder is blended, the sliding characteristics for shaft 2, circular cylindrical portion 21a of forming mold 20 and the like are improved. Carbon nano fibers are classified roughly into a pitch-based type and a PAN-based type, both of which can be used. A carbon nano fiber having an average fiber diameter of 20 μm or less and an average fiber length of 0.02 mm to 0.2 mm can be used, for example.

A binder can also be included in the carbon material powder (for example, graphite powder). Resin binder powder can be used as a binder while phenol resin powder can be used as resin binder powder, for example. It is preferable that a molding assistant, a lubricant, a modifier or the like is added as required to uniformly mix the carbon material powder with the binder.

Examples of raw material powder constituting lubricating member 3 may be a powder mixture of carbon material powder and resin binder powder as described above, and also, granulated powder obtained by granulating the carbon material powder through intervention of the resin binder. Granulated powder is higher in specific gravity and fluidity than resin binder powder alone or carbon material powder alone. Thus, the resin composition containing granulated powder can be readily supplied to a forming mold, and can be molded into a prescribed shape with accuracy.

In bearing 1, lubricating member 3 constituting a part of bearing surface portion 11 serves as a supply source of a carbon material. The carbon material supplied from lubricating member 3 is spread throughout bearing surface portion 11 by the relative movement of bearing surface portion 11 and shaft 2. Thereby, the lubrication effect by the carbon material can be achieved throughout bearing surface portion 11.

The resin composition may contain other filler materials in addition to a thermoplastic resin and a carbon material. Examples of other filler materials may be: fibers such as a glass fiber, an aramid fiber, an alumina fiber, an aromatic polyamide fiber, a polyester fiber, a boron fiber, a silicon carbide fiber, a boron nitride fiber, a silicon nitride fiber, and a metal fiber, and fibers knitted in a cloth shape; minerals such as calcium carbonate, talc, silica, clay, and mica; inorganic whiskers such as an aluminum borate whisker and a potassium titanate whisker; a polyimide resin, polybenzimidazole; and the like. By containing these filler materials, the frictional wear characteristics of lubricating member 3 can be improved while the coefficient of linear expansion can be reduced. Also, additive agents such as a release agent, a flame retardant, a weather resistance modifier, an antioxidant, and a pigment may be appropriately added as required.

The content of the carbon material blended with the resin composition is set to fall within a suitable range in order to ensure the sliding characteristics of the sliding surface of lubricating member 3. The content of the carbon material is set to be approximately 5% by mass or more and approximately 70% by mass or less, specifically 5% by mass or more and 70% by mass or less, preferably approximately 10% by mass or more and approximately 60% by mass or less, specifically 10% by mass or more and 60% by mass or less, more preferably approximately 50% by mass or less, specifically 50% by mass or less, and further preferably approximately 40% by mass or less, and specifically 40% by mass or less. In the case where the blending amount of the carbon material in the resin composition is less than approximately 5% by mass, specifically less than approximately 10% by mass, and further specifically less than 10% by mass, the blending amount of carbon material is relatively small, so that the effect of improving the sliding characteristics of the sliding surface by the carbon material tends to be hardly achieved. In the case where the blending amount of the carbon material in the resin composition is more than approximately 70% by mass, specifically more than approximately 60% by mass, further specifically more than approximately 50% by mass, and particularly specifically more than 50% by mass, the fluidity of the resin composition is reduced to thereby reduce the yield rate during injection molding, and also, injection molding tends to be difficult to be performed.

In order to avoid reduction in yield rate during injection molding while ensuring the sliding characteristics, the content of the carbon material blended with the resin composition is preferably set to fall within the above-described range, and more preferably approximately 40% by mass or less and specifically 40% by mass or less.

Bearing 1 has numberless inner pores. Thus, the inner pores in bearing 1 having undergone the insert molding step can be impregnated with oil. Specifically, after bearing 1 having undergone the insert molding step is immersed in the lubricating oil under a decompression environment, the decompressed pressure is returned to atmospheric pressure, so that the inner pores in bearing 1 is impregnated with oil. Lubricating oil is not particularly limited as long as it is commonly used for a bearing, and for example may be: mineral oil such as spindle oil, refrigeration oil, turbine oil, machine oil, and dynamo oil, hydrocarbon-based synthetic oil such as polybutene, poly-α-olefin, alkyl naphthalene, and an alicyclic compound; or ester such as ester oil of natural oil/fat and polyol, phosphate ester, and diester oil; non-hydrocarbon-based synthetic oil such as polyglycol oil, silicone oil, polyphenylether oil, alkyldiphenyl ether oil, alkylbenzene, and fluorinated oil; liquid grease; or the like.

The open porosity of base body 4 is set to fall within a suitable range in order to improve the sliding characteristics of bearing 1 by the oil functioning as a lubricity imparting agent in the case where each inner pore in bearing 1 having undergone the insert molding step is impregnated with this oil. The open porosity of base body 4 is approximately 5% or more, specifically 5% or more, preferably approximately 10% or more, specifically 10% or more, more preferably approximately 15% or more, and specifically 15% or more. Furthermore, the open porosity of base body 4 is approximately 50% or less, specifically 50% or less, preferably approximately 40% or less, specifically 40% or less, more preferably approximately 30% or less, specifically 30% or less, further more preferably approximately 25% or less, and specifically 25% or less. When the open porosity is less than approximately 5% (specifically 5%), the total amount of the oil with which each inner pore in base body 4 is impregnated is relatively small. This leads to a tendency that it becomes difficult for bearing 1 to achieve excellent lubrication performance based on the lubricating oil for a long period of time. Furthermore, when the open porosity is greater than approximately 50% (specifically 50%), base body 4 is difficult to be molded, so that the moldability of base body 4 decreases. As a result, it becomes difficult to mold base body 4 with excellent productivity. Thus, production of bearing 1 including base body 4 at low cost tends to be difficult. In order to mold bearing 1 with excellent productivity while allowing base body 4 to exhibit its excellent lubrication performance with the help of lubricating oil, it is preferable that the open porosity of base body 4 falls within the above-described range. In addition, the “open porosity” represents the percentage of the inner pores, which can be impregnated, with respect to the volume of base body 4 and is calculated by dividing the volume of oil after complete impregnation by the volume of base body 4 and multiplying the divided result by 100. The open porosity can be measured by “Sintered metal materials-Determination of density, oil content and open porosity (JIS Z 2501: 2000)” defined by the Japanese Industrial Standards.

The inner pores in this base body 4 are impregnated with lubricating oil such as mineral oil or synthetic oil, for example, as a lubricant. Thus, when base body 4 rotates with respect to shaft 2, the lubricating oil kept in the inner pores in base body 4 exudes from the surface pores on inner circumferential surface 4a of base body 4, thereby forming an oil film of lubricating oil between inner circumferential surface 4a (sliding surface portion 11) and the outer circumferential surface of shaft 2. Thereby, wear of sliding surface portion 11 is suppressed or prevented. The oil content in the entire base body 4 is set to be approximately 5 vol % or more, specifically 5 vol % or more, preferably approximately 10 vol % or more, specifically 10 vol % or more, more preferably approximately 15 vol % or more, and specifically 15 vol % or more. Furthermore, the oil content in the entire base body 4 is set to be approximately 50 vol % or less, specifically 50 vol % or less, preferably approximately 40 vol % or less, specifically 40 vol % or less, more preferably approximately 30 vol % or less, specifically 30 vol % or less, further more preferably approximately 25 vol % or less, and specifically 25 vol % or less. When the oil content is less than approximately 5 vol %, specifically approximately 10 vol %, more specifically approximately 15 vol %, and further more specifically 15 vol %, desired lubrication characteristics cannot be stably maintained and exhibited for a long period of time. This is because, when the oil content is more than approximately 50 vol %, specifically approximately 40 vol %, more specifically approximately 30 vol %, further more specifically approximately 25 vol %, and particularly specifically 25 vol %, the inner porosity is increased, so that the mechanical strength required for the entire base body 4 may not be able to be ensured.

At too low viscosity of the lubricating oil with which the inner pores in base body 4 are impregnated, the lubricating oil is more likely to flow to the outside and the oil film rigidity is reduced, so that the effect of suppressing wear of sliding surface portion 11 may be insufficient. On the other hand, at too high viscosity of the lubricating oil, the amount of lubricating oil exuding from the surface pores in sliding surface portion 11 is insufficient, so that the oil film having prescribed thickness and rigidity may not be able to be formed. From the above-described point of view, the kinematic viscosity of the lubricating oil at 40° C. is set to be approximately 5 mm²/s or more, specifically 5 mm²/s or more, preferably approximately 30 mm²/s or more, specifically 30 mm²/s or more, more preferably approximately 50 mm²/s or more, and specifically 50 mm²/s or more. Also, the kinematic viscosity of the lubricating oil at 40° C. is set to be approximately 600 mm²/s or less, specifically 600 mm²/s or less, preferably approximately 550 mm²/s or less, specifically 550 mm²/s or less, more preferably approximately 500 mm²/s or less, and specifically 500 mm²/s or less.

In addition, the inner pores in base body 4 may be impregnated with liquid grease in place of the above-described lubricating oil. Examples of liquid grease may be grease obtained by adding a soap-based thickening agent such as lithium soap or non-soap-based thickening agent such as urea to the lubricating oil, as base oil, having kinematic viscosity falling within the above-described range at 40° C.

The surface porosity in mating face 4b as an inner surface of housing portion 4c in base body 4 is set to fall within a suitable range in order to enhance the coupling strength between base body 4 and lubricating member 3 by the anchor effect of the thermoplastic resin contained in lubricating member 3 disposed in housing portion 4c of base body 4. The surface porosity is preferably 10% or more and 50% or less. When the surface porosity is less than 10%, the amount of thermoplastic resin contained in lubricating member 3 and flowing into the surface pores in mating face 4b is reduced. Accordingly, the anchor effect of the thermoplastic resin tends to decrease. Furthermore, when the surface porosity is more than 50%, molding of housing portion 4c tends to be difficult. It is preferable that the surface porosity of base body 4 falls within the above-described range in order to mold bearing 1 with excellent productivity while enhancing the coupling strength between base body 4 and lubricating member 3. The “surface porosity” means the proportion (area ratio) of the total area of the surface pores per surface unit area. Also, the surface porosity used herein can be obtained, for example, by calculating the area of the pore portion using the image taken by a metallographic microscope such as ECLIPSE ME600 manufactured by Nikon Corporation (for example, 500 times magnification) and captured as image date in a computer, for the sake of convenience.

The material of the shaft is not particularly limited, and the shaft can be formed using various materials such as SS steel, S-C steel, SCM steel, SUJ steel, and SUS steel. The hardness of steel may be approximately HRC30 to HRC60 (HB286 to HB654), or may be approximately HB140 to HB220. Also, the hardness after the quenching process may be approximately HRC55 to HRC70, preferably HRC55 to HRC60, or approximately HRC60 to HRC65 In this way, a plain bearing apparatus including sliding member 1 and shaft 2 may be fabricated.

The above-described embodiments have been explained with regard to the configuration in which inside surface 3a of lubricating member 3 and inner circumferential surface 4a of base body 4 are arranged in the same cylindrical surface shape to form bearing surface portion 11, but the present invention is not limited thereto. In the following, other embodiments of the present invention will be described, but the same description as those of the above-mentioned embodiments will not be repeated.

### Other Embodiments

Referring to FIG. 5, bearing 1 may be manufactured in such a manner that inside surface 3a of lubricating member 3 is disposed on the inner diameter side of inner circumferential surface 4a of base body 4 so as to form bearing surface portion 11 only using inside surface 3a of lubricating member 3. In this case, it is preferable that inside surfaces 3a of the plurality of lubricating members 3 are disposed on the same cylindrical surface.

Furthermore, lubricating member 3 may be disposed over the entire length of bearing 1 in the axial direction as shown in FIG. 1(b), and additionally, may be disposed only along a partial region in the axial direction, or may be disposed at a plurality of positions spaced apart from each other in the axial direction, for example.

### REFERENCE SIGNS LIST

1 sliding member (bearing), 2 shaft, 3 lubricating member. 3a inside surface, 3b outside surface, 4 base body, 4′ compact, 4a inner circumferential surface, 4a′ recessed portion, 4b mating face, 4c housing portion, 11 bearing surface portion (sliding surface portion), 12 outer circumferential surface, 20 forming mold, 21 fixed mold, 21a circular cylindrical portion, 21b gate, 21c molding surface, 21d runner, 22 movable mold, 23 cavity.

1. A sliding member having a sliding surface that is at least partially formed of a surface of a lubricating member, the sliding member comprising:
a base body as a sintered body of a compact containing metal powder, the base body being integrated with the lubricating member; and
the lubricating member as an injection molded product of a resin composition containing a polyarylene sulfide-based resin and a carbon material.

2. A sliding member having a sliding surface that is at least partially formed of a surface of a lubricating member, the sliding member comprising:
a base body as a sintered body of a compact containing metal powder, the base body having a housing portion in which the lubricating member is to be housed; and
the lubricating member as an injection molded product of a resin composition containing a polyarylene sulfide-based resin and a carbon material, the lubricating member being disposed in the housing portion.

3. The sliding member according to claim 1, wherein a content of the carbon material in the resin composition is approximately 5% by mass or more and approximately 70% by mass or less.

4. The sliding member according to claim 1 wherein
the base body has an inner pore, and
the inner pore is impregnated with lubricating oil.

5. The sliding member according to claim 1, wherein the base body has an open porosity of approximately 5% or more and approximately 50% or less.

6. The sliding member according to claim 1, wherein the base body has a surface porosity of approximately 10% or more and approximately 50% or less.

7. The sliding member according to claim 2, wherein the housing portion of the base body has an inner surface having a surface porosity of approximately 10% or more and approximately 50% or less.

8. The sliding member according to claim 1, wherein the carbon material is at least one selected from the group consisting of a carbon nano fiber, carbon black and graphite.

9. The sliding member according to claim 2, wherein a content of the carbon material in the resin composition is approximately 5% by mass or more and approximately 70% by mass or less.

10. The sliding member according to claim 2, wherein
the base body has an inner pore, and
the inner pore is impregnated with lubricating oil.

11. The sliding member according to claim 2, wherein the base body has an open porosity of approximately 5% or more and approximately 50% or less.

12. The sliding member according to claim 2, wherein the base body has a surface porosity of approximately 10% or more and approximately 50% or less.

13. The sliding member according to claim 2, wherein the carbon material is at least one selected from the group consisting of a carbon nano fiber, carbon black and graphite.
